(19) United States
(12) Patent Application Publication
(10) Pub. No.: US 2014/0144304 A1
(43) Pub. Date: May 29, 2014

(54) PUNCHER

(71) Applicant: SDI CORPORATION, Chang Hua (TW)

(72) Inventor: Chih-Wei HSU, CHANG HUA (TW)

(73) Assignee: SDI CORPORATION, CHANG HUA (TW)

(21) Appl. No.: 13/685,371

(22) Filed: Nov. 26, 2012

(51) Int. Cl. B26F 1/02

(52) U.S. Cl. CPC B26F 1/02
USPC 83/167; 83/588

(57) ABSTRACT

A puncher has a base, an upper cover, two cutters and at least one spring. The base is made of plastic and has a base recess capable of receiving paper. The upper cover is made of plastic and is pivotally connected to the base. The cutters are mounted on the base, are capable of being driven by the upper cover and longitudinally moving relative to the base, and are located between a pivoting point and an opening of the base recess. The at least one spring is mounted between the base and the upper cover. Accordingly, the puncher has a reverse-fulcrum structure.

### BACKGROUND OF THE INVENTION

1. Field of the Invention

The present invention relates to a puncher, and more particularly to a puncher having a reverse-fulcrum structure and being easily manufactured.

2. Description of Related Art

With reference to FIG. 9, a conventional puncher has a base 60, an upper cover 62, a pivoting point 64, two cutters 66 and a base recess 68. The upper cover 62 is pivotally connected to the base 60. The pivoting point 64 is formed between the base 60 and the upper cover 62. The cutters 66 are mounted on the upper cover 62 and capable of being driven by the upper cover 62. The base recess 68 has an opening.

When paper sheets are inserted into the base recess 68, the upper cover 62 is pressed to pivot relative to the base 60, and the cutters 66 are driven to punch the paper sheets. Accordingly, the punched paper sheets can be easily received by a loose-leaf binder.

However, the conventional puncher is made of metal, is heavy, and needs to be bored or lacquered, all of which are inconvenient for manufacturing.

The opening of the base recess 68 and the pivoting point 64 are both located at the same side of the cutters 66, so the conventional puncher has a normal-fulcrum structure. An upward reaction force is generated when the cutters 66 punch the paper sheets, and is applied to the pivoting point 64. Accordingly, the base recess 68 is easily deformed by the reaction force, and the amount of paper sheets punched by the puncher is reduced, whereby the conventional puncher is inconvenient in use.

In addition, a Japan patent “perforating punch”, Japan publication number 06-344298, has disclosed a punch having a reverse-fulcrum structure. The reverse-fulcrum structure refers to that opening of the base recess and the pivoting point are respectively located at two opposite sides of the cutters. Although the puncher in the referenced Japan patent can reduce the reaction force applied to the pivoting point, the structure of the puncher is still complex. Components of the puncher are made of metal, and need to be electroplated, lacquered or bored, and thus the referenced Japan punch is not easily manufactured, and the manufacture is still costly.

To overcome the shortcomings, the present invention tends to provide a puncher to mitigate the aforementioned problems.

### SUMMARY OF THE INVENTION

The main objective of the invention is to provide a puncher having a simplified structure, such that the puncher can be manufactured by a simplified production process and the manufacturing costs are reduced.

A puncher has a base, an upper cover, two cutters and at least one spring. The base is made of plastic and has a base recess capable of receiving paper. The upper cover is made of plastic and is pivotally connected to the base. The cutters are mounted on the base, are capable of being driven by the upper cover and longitudinally moving relative to the base, and are located between a pivoting point and an opening of the base recess. The at least one spring is mounted between the base and the upper cover. Accordingly, the puncher has a reverse-fulcrum structure.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a puncher in accordance with the present invention;

FIG. 2 is a partially exploded perspective view of the puncher in FIG. 1;

FIG. 3 is a front view of the puncher in FIG. 1;

FIG. 4 is a side view in partial section of the puncher in FIG. 3 along line 4-4;

FIG. 5 is a side view in partial section of the puncher in FIG. 3 along line 5-5;

FIG. 6 is an operational view of the puncher in FIG. 1 showing that the upper cover is pivoted downward;

FIG. 7 is an operational perspective rear view of the puncher in FIG. 1 showing that a smart phone is placed in the first cavity;

FIG. 8 is an operational perspective rear view of the puncher in FIG. 1 showing that clips are placed in the second cavity; and

FIG. 9 is a side view of a conventional puncher in accordance with the prior art.

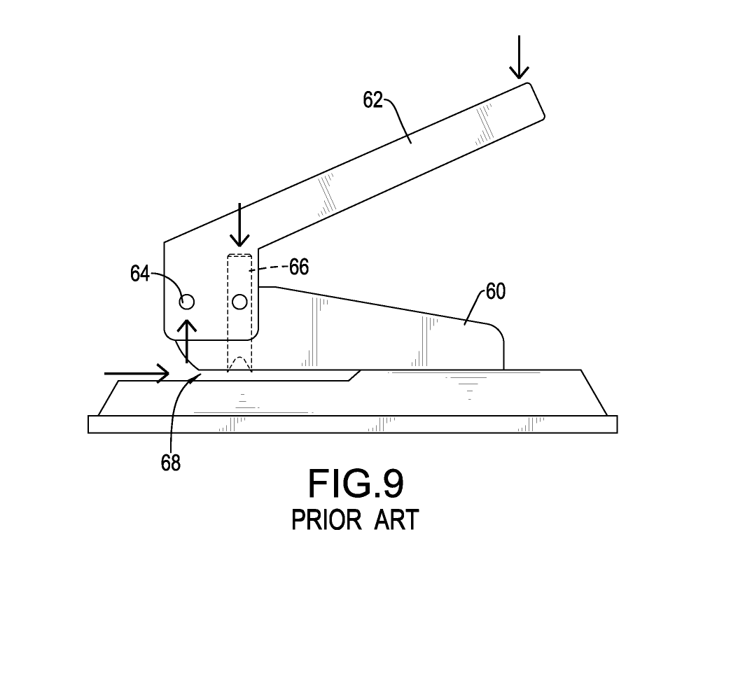

### DETAILED DESCRIPTION OF PREFERRED EMBODIMENT

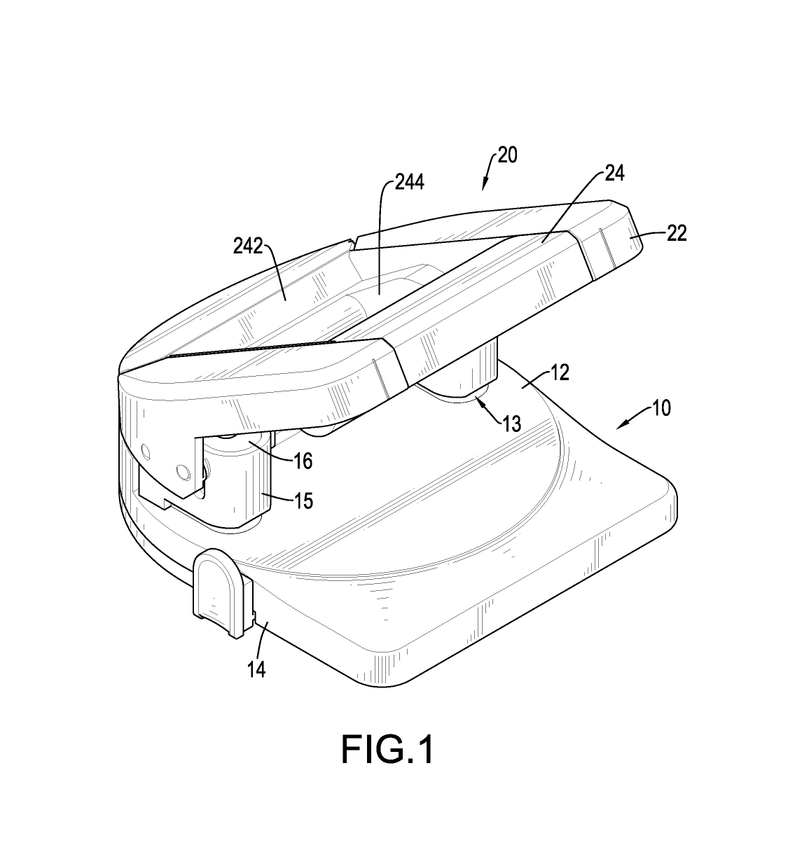

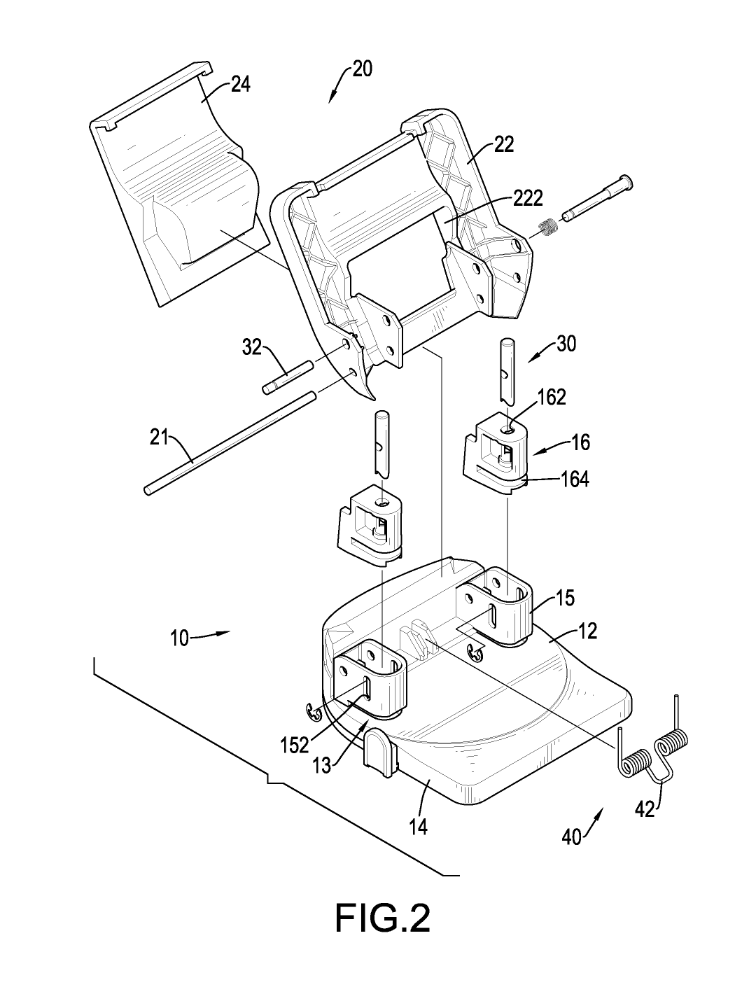

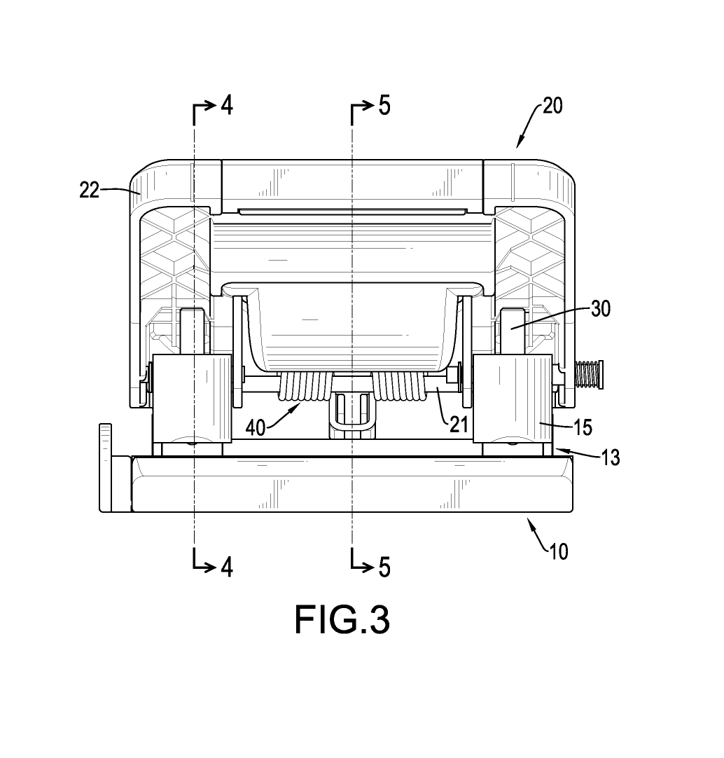

With reference to FIGS. 1 to 3, a puncher in accordance with the present invention mainly comprises a base 10, an upper cover 20, two cutters 30 and at least one spring 40.

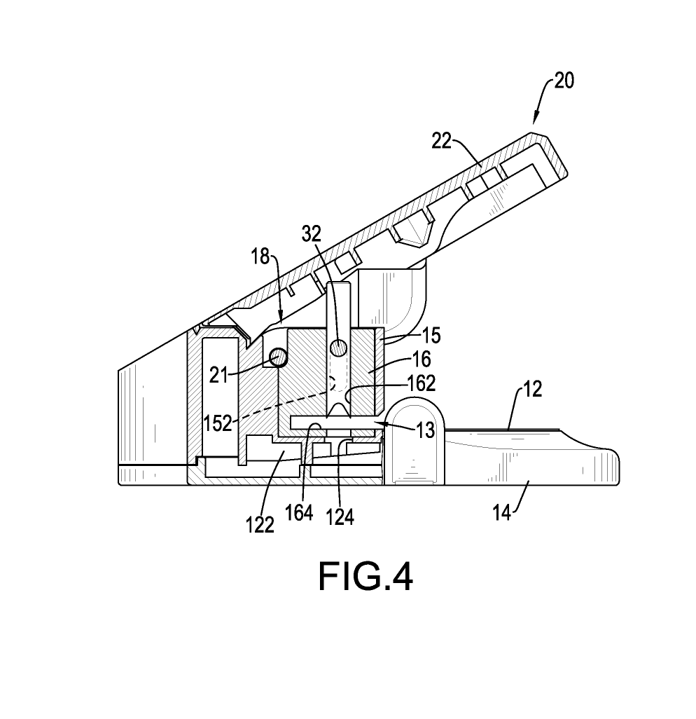

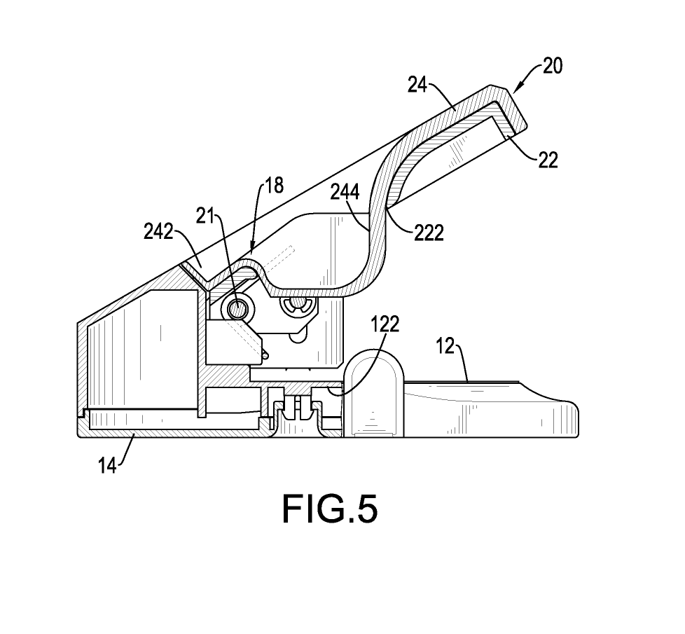

With further reference to FIGS. 4 and 5, the base 10 is made of plastic and has a bracket 12, a base recess 13, a bottom cover 14, two frames 15 and two cutter mounts 16.

The bracket 12 may be round, square or any other geometric shape. The bracket 12 has a bottom, a top surface and a base space 122. The bottom of the bracket 12 is hollow. The base space 122 is formed inside the bottom of the base 10.

The bottom cover 14 detachably covers the bottom of the bracket 12 of the base 10 to close the base space 122 such that the base space 122 can receive scraps that are separated from punched paper sheets.

The frames 15 are connected on the top surface of the bracket 12, are parallel to each other and respectively have a bottom surface.

A gap is formed between the top surface of the bracket 12 and the bottom surfaces of the two frames 15. The base recess 13 is formed at the gap between the two frames 15 and the bracket 12, is capable of receiving paper and has an opening. The opening of the base recess 13 allows paper to be mounted therethrough. The bracket 12 has two cutter through holes 124. The cutter through holes 124 are formed in the top surface of the bracket 12, respectively face the two frames 15 and communicate with the base space 122.

The cutter mounts 16 are respectively and securely mounted in the frames 15. Each cutter mount 16 is made of plastic and has a side surface, a bottom surface, a cutter aperture 162 and a paper opening 164. The cutter aperture 162 of each cutter mount 16 is formed through the cutter mount 16. The cutter apertures 162 respectively align with the cutter through holes 124. The paper opening 164 of each cutter mount 16 is latitudinally formed in the side surface of the cutter mount 16, is adjacent to the bottom surface of the cutter mount 16, and aligns with and communicates with the base recess 13.

The upper cover 20 is made of plastic and is pivotally connected to the base 10. A pivoting point 18 is formed between the base 10 and the upper cover 20. Preferably, an end of the upper cover 20 is pivotally connected with the base 10 by at least one axle 21 and is inclined relative to the base 10. The at least one axle 21 forms the pivoting point 18. Preferably, each frame 15 has a mounting end opposite to the base recess 13. The upper cover 20 is pivotally connected with the mounting ends of the two frames 15.

Preferably, the upper cover 20 has a main body 22 and a lid 24. The main body 22 is pivotally connected with the base 10 by the axle 21 and has a central area, a through opening 222, a first side surface and a second side surface. The through opening 222 is formed through the central area of the main body 22. The first side surface of the main body 22 faces the base 10. The second side surface of the main body 22 is opposite to the first side surface.

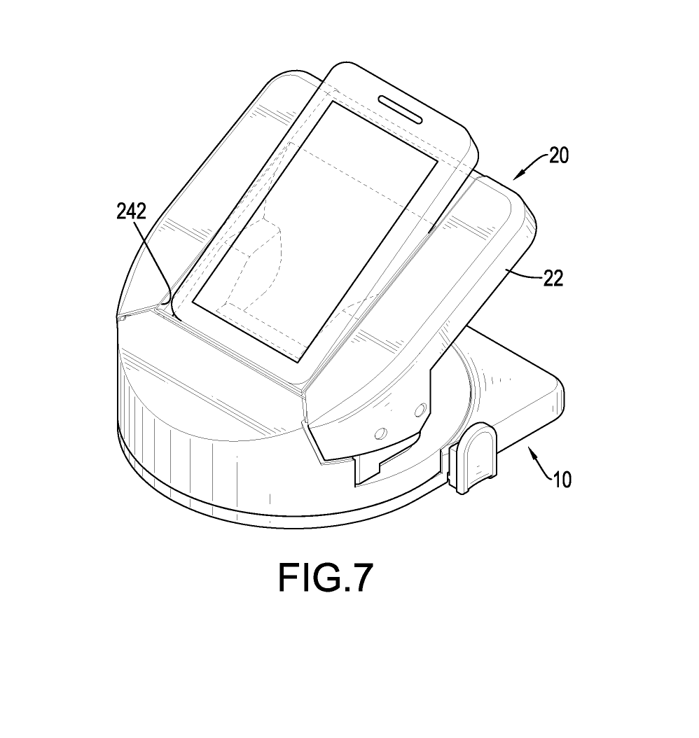

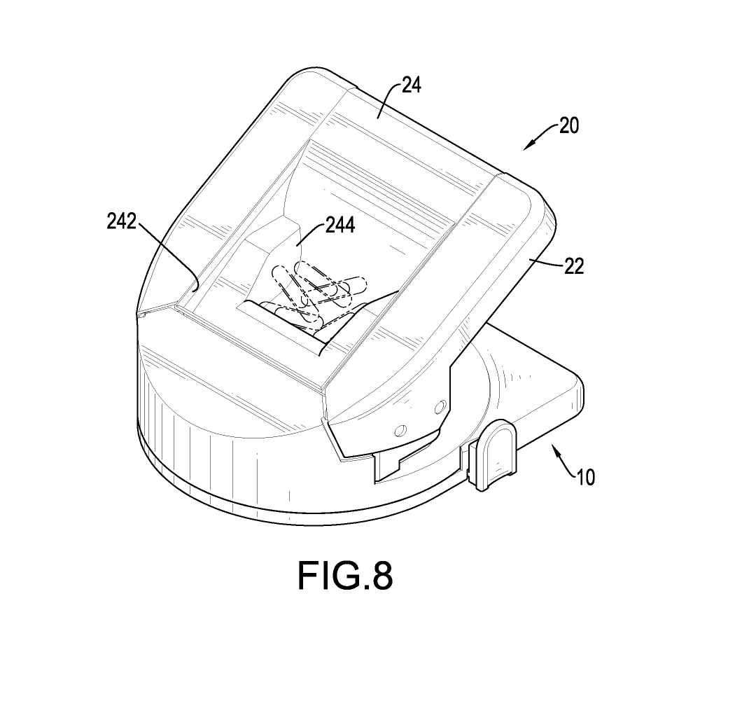

The lid 24 is mounted on the second surface of the main body 22 and has an inclined first cavity 242. The inclined first cavity 242 is formed in a central area of a top surface of the lid 24 and has a bottom surface. The first cavity 242 can receive a smart phone, as shown in FIG. 7, such that the smart phone is positioned on the upper cover 20. Preferably, the lid 24 has a stationery hump and a second cavity 244. The stationery hump protrudes from a central area of a bottom surface of the lid 24 and is mounted through the through opening 222. The second cavity 244 is formed in the bottom surface of the first cavity 242 and can receive clips or staples, as shown in FIG. 8. Accordingly, the puncher does not only have a punching function, but also can receive small stationery items.

The cutters 30 are made of metal, are respectively and slidably inserted into the cutter apertures 162 and are located between the pivoting point 18 and the opening of the base recess 13 such that the puncher has a reverse-fulcrum structure. Preferably, each cutter 30 has a top end protruding out from a corresponding one of the cutter apertures 162 and facing a bottom surface of the upper cover 20.

To enable the cutters 30 to be steadily slid in the cutter apertures 162, preferably, each frame 15 has two guiding holes 152 formed through two side surfaces of the frame 15 and longitudinally extending respectively. Each cutter 30 has a guiding rod 32 protruding from the cutter 30, mounted in the guiding holes 152 of a corresponding one of the frames 15, capable of sliding along the guiding holes 152, and having two opposite ends respectively connected with the upper cover 20. With the guiding holes 152 and the guiding rods 32, the cutters 30 can be steadily slid relative to the cutter apertures 162.

In addition, the base 10 may not have the cutter mounts 16. Instead, each of the frames 15 has a solid top and a solid bottom. Each cutter 30 is mounted through the top and the bottom of a corresponding one of the frames 15. Accordingly, the frames 15 can also guide the cutters 30.

The at least one spring 40 is mounted between the base 10 and the upper cover 20 to provide a resilient force to recover the upper cover 20 to an original position.

Preferably, the amount of the spring 40 may be one, and the spring 40 is a torsion spring. The spring 40 is mounted at the pivoting point 18. Preferably, the spring 40 is mounted around the axle 21 pivotally connected with the base 10 and the upper cover 20.

Part of the spring 40 abuts the base 10 and the upper cover 20. The spring 40 has two opposite ends, a central area and an abutting portion 42.

The opposite ends of the spring 40 abut the bottom surface of the upper cover 20. The abutting portion 42 protrudes from the central area of the spring 40 and abuts a top surface of the base 10.

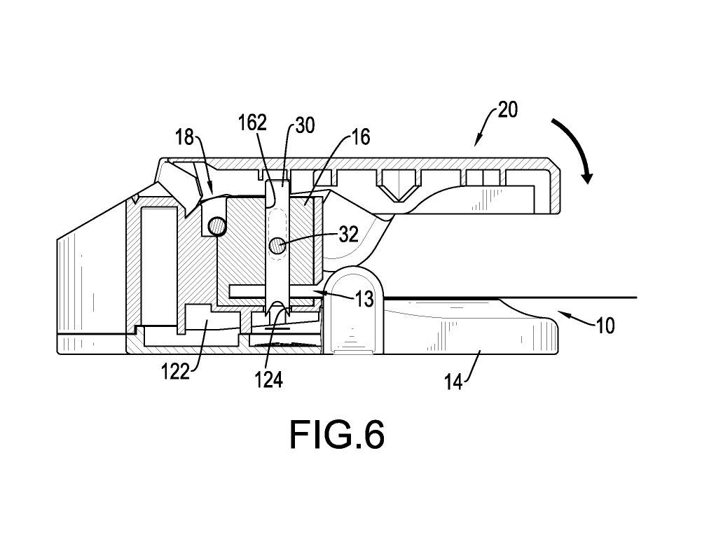

With reference to FIG. 6, the puncher in accordance with the present invention is used to punch multiple pieces of paper.

First, an edge of the paper sheets is inserted into the base recess 13 and faces the cutters 30.

Second, the upper cover 20 is pressed to pivot relative to the base 10. The upper cover 20 drives the cutters 30 to descend toward the cutter apertures 162 such that the paper sheets are punched by the cutters 30. Scraps separated from the punched paper sheets enter the base space 122 via the cutter through holes 124.

Finally, the upper cover 20 is released, is recovered to an original position by the resilient force provided by the spring 40, and drives the guiding rods 32 and the cutters 30 to ascend for subsequent punching.

From the above description, it is noted that the present invention has the following advantages:

Because components of the puncher in accordance with the present invention are reduced, the structure of the puncher is compact.

Because the puncher has the reverse-fulcrum structure, a reaction force applied to the pivoting point 18 is reduced, deformation of the base recess 13 is effectively prevented, and amounts of the paper sheets, which are able to be punched by the puncher on condition that the puncher bears deformation, can be increased.

The base 10, the upper cover 20 and the cutter mounts 16 are made of plastic, so the weight of the puncher is reduced. Components of the puncher do not need to be electroplated, lacquered, or bored and are easily manufactured and assembled.

The cutter mounts 16 ensure that the cutter apertures 162 align with the cutter through holes 124. Moreover, the components of the puncher are easily manufactured by molding, and the manufacturing cost of the puncher in accordance with the prevent invention is reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A puncher comprising:
a base made of plastic and having
a base recess capable of receiving paper and having an opening;
an upper cover made of plastic, pivotally connected to the base, wherein a pivoting point is formed between the base and the upper cover;
two cutters mounted on the base, capable of being driven by the upper cover and longitudinally moving relative to the base, and located between the pivoting point and the opening of the base recess; and
at least one spring mounted between the base and the upper cover to provide a resilient force to recover the upper cover to an original position.

2. The puncher as claimed in claim 1, wherein
the base has
a bracket; and
two frames connected on a top surface of the bracket, parallel to each other and respectively having a bottom surface; and
a gap formed between the top surface of the bracket and the bottom surfaces of the two frames; and
the base recess is formed at the gap between the two frames and the bracket.

3. The puncher as claimed in claim 2, wherein
the base further has two cutter mounts respectively and securely mounted in the frames;
each cutter mount is made of plastic and has
a side surface;
a bottom surface;
a cutter aperture formed through the cutter mount;
a paper opening latitudinally formed in the side surface of the cutter mount, adjacent to the bottom surface of the cutter mount, and aligning with and communicating with the base recess; and
the cutters are respectively mounted in the cutter apertures.

4. The puncher as claimed in claim 3, wherein
a bottom of the base is hollow, and a base space is formed inside the bottom of the base;
the base further has a bottom cover detachably covering the bottom of the base to close the base space; and
the bracket has two cutter through holes formed in the top surface of the bracket, respectively facing the two frames, communicating with the base space, and respectively aligning with the cutter apertures.

5. The puncher as claimed in claim 2, wherein the bracket has a round cross section.

6. The puncher as claimed in claim 4, wherein the bracket has a round cross section.

7. The puncher as claimed in claim 5, wherein
an end of the upper cover is pivotally connected with the base by at least one axle and is inclined relative to the base; and the at least one axle forms the pivoting point.

8. The puncher as claimed in claim 6, wherein
an end of the upper cover is pivotally connected with the base by at least one axle and is inclined relative to the base; and the at least one axle forms the pivoting point.

9. The puncher as claimed in claim 7, wherein
each frame has a mounting end opposite to the base recess; and
the upper cover is pivotally connected with the mounting ends of the two frames.

10. The puncher as claimed in claim 8, wherein
each frame has a mounting end opposite to the base recess; and
the upper cover is pivotally connected with the mounting ends of the two frames.

11. The puncher as claimed in claim 9, wherein
the upper cover has
a main body pivotally connected with the base by the at least one axle and having
a central area;
a through opening formed through the central area of the main body;
a first side surface facing the base; and
a second surface opposite to the first surface; and
a lid mounted on the second surface of the main body and having an inclined first cavity formed in a top surface of the lid.

12. The puncher as claimed in claim 10, wherein
the upper cover has
a main body pivotally connected with the base by the at least one axle and having
a central area;
a through opening formed through the central area of the main body;
a first side surface facing the base; and
a second surface opposite to the first surface; and
a lid mounted on the second surface of the main body and having an inclined first cavity formed in a top surface of the lid.

13. The puncher as claimed in claim 11, wherein
the lid has a stationery hump protruding from a bottom surface of the lid and mounted through the through opening; and a second cavity is formed in a bottom surface of the first cavity.

14. The puncher as claimed in claim 12, wherein
the lid has a stationery hump protruding from a bottom surface of the lid and mounted through the through opening; and
a second cavity is formed in a bottom surface of the first cavity.

15. The puncher as claimed in claim 13, wherein
each cutter has a top end protruding out from a corresponding one of the cutter apertures and facing a bottom surface of the upper cover.

16. The puncher as claimed in claim 14, wherein
each cutter has a top end protruding out from a corresponding one of the cutter apertures and facing a bottom surface of the upper cover.

17. The puncher as claimed in claim 15, wherein
each frame has two guiding holes formed through two side surfaces of the frame and longitudinally extending respectively; and
each cutter has a guiding rod protruding from the cutter, mounted in the guiding holes of a corresponding one of the frames, capable of sliding along the guiding holes, and having two opposite ends respectively connected with the upper cover.

18. The puncher as claimed in claim 16, wherein
each frame has two guiding holes formed through two side surfaces of the frame and longitudinally extending respectively; and
each cutter has a guiding rod protruding from the cutter, mounted in the guiding holes of a corresponding one of the frames, capable of sliding along the guiding holes, and having two opposite ends respectively connected with the upper cover.

19. The puncher as claimed in claim 17, wherein
the spring is a torsion spring and is mounted around the axle pivotally connected with the base and the upper cover.

20. The puncher as claimed in claim 18, wherein
the spring is a torsion spring and is mounted around the axle pivotally connected with the base and the upper cover.

21. The puncher as claimed in claim 19, wherein
the spring has
two opposite ends abutting the bottom surface of the upper cover;
a central area; and
an abutting portion protruding from the central area of the spring and abutting a top surface of the base.

22. The puncher as claimed in claim 20, wherein
the spring has
two opposite ends abutting the bottom surface of the upper cover;
a central area; and
an abutting portion protruding from the central area of the spring and abutting a top surface of the base.

23. The puncher as claimed in claim 1, wherein
an end of the upper cover is pivotally connected with the base by at least one axle and is inclined relative to the base; and the at least one axle forms the pivoting point.

24. The puncher as claimed in claim 1, wherein
the upper cover has
a main body pivotally connected with the base by at least one axle and having
a central area;
a through opening formed through the central area of the main body;
a first side surface facing the base; and
a second surface opposite to the first surface; and
a lid mounted on the second surface of the main body and having an inclined first cavity formed in a central area of a top surface of the lid.

25. The puncher as claimed in claim 24, wherein
the lid has a stationery hump protruding from a bottom surface of the lid and mounted through the through opening; and
a second cavity is formed in a bottom surface of the first cavity.

26. The puncher as claimed in claim 3, wherein
each cutter has a top end protruding out from a corresponding one of the cutter apertures and facing a bottom surface of the upper cover.

27. The puncher as claimed in claim 4, wherein
each cutter has a top end protruding out from a corresponding one of the cutter apertures and facing a bottom surface of the upper cover.

28. The puncher as claimed in claim 26, wherein
each frame has two guiding holes formed through two side surfaces of the frame and longitudinally extending respectively; and
each cutter has a guiding rod protruding from the cutter, mounted in the guiding holes of a corresponding one of the frames, capable of sliding along the guiding holes, and having two opposite ends respectively connected with the upper cover.

29. The puncher as claimed in claim 27, wherein
each frame has two guiding holes formed through two side surfaces of the frame and longitudinally extending respectively; and
each cutter has a guiding rod protruding from the cutter, mounted in the guiding holes of a corresponding one of the frames, capable of sliding along the guiding holes, and having two opposite ends respectively connected with the upper cover.

30. The puncher as claimed in claim 1, wherein
the spring is a torsion spring and is mounted at the pivoting point pivotally connected with the base and the upper cover.

31. The puncher as claimed in claim 30, wherein
the spring has
two opposite ends abutting a bottom surface of the upper cover;
a central area; and
an abutting portion protruding from the central area of the spring and abutting a top surface of the base.
